(19) United States
(12) Patent Application Publication
(10) Pub. No.: US 2015/0171689 A1
(43) Pub. Date: Jun. 18, 2015

(54) MOTOR, PRODUCTION METHOD FOR MOTOR AND TURBO-BLOWER APPARATUS

(71) Applicant: FANUC CORPORATION, Minamitsuru-gun (JP)

(72) Inventor: Takashi Wada, Yamanashi (JP)

(73) Assignee: FANUC CORPORATION, Minamitsuru-gun (JP)

(21) Appl. No.: 14/568,941

(22) Filed: Dec. 12, 2014

(30) Foreign Application Priority Data
Dec. 16, 2013 (JP) 2013-258988

(51) Int. Cl. H02K 3/32; F04D 25/06; H02K 9/19

(52) U.S. Cl. CPC H02K 3/32; H02K 9/19; F04D 25/06

(57) ABSTRACT

A motor including: a stator core extending in a direction of an axis line constituting a rotation center; a stator coil formed by winding a winding wire on the stator core; and a resin mold unit of a substantially cylindrical shape centered on the axis line, the resin mold unit covering an end portion in the direction of the axis line of the stator coil, the motor being configured to supply a coolant to a surface of the resin mold unit. The motor is arranged so that the axis line is directed in a substantially vertical direction, and the resin mold unit includes a spiral groove portion entered on the axis line at least either an inner circumferential surface or an outer circumferential surface of the resin mold unit.

### BACKGROUND OF THE INVENTION

1. Field of the Invention

The present invention relates to a motor for driving a turbo-blower or the like, a production method for a motor, and a turbo-blower apparatus.

2. Description of the Related Art

Conventionally, a motor described in Japanese Laid-open Patent Publication No. 8-098441 (JP8-098441A) is known as a motor (molded motor) formed with a resin mold unit in a circumference of a stator iron core. In the motor described in JP8-098441A, a plurality of recessed grooves are formed in an outer circumference of a resin mold unit to enhance heat radiation efficiency of the motor. The recessed grooves are formed parallel to a rotation axis line direction of the motor or are circularly formed centered on the rotation axis line of the motor.

However, when the motor described in JP8-098441A is configured so that, for example, the rotation axis line is directed in a vertical direction and further cooling oil flows on a surface of the motor, the oil may flow non-uniformly in a circumferential direction or may remain on the way of the recessed groove. Therefore, a sufficient cooling effect for the motor is not achievable.

### SUMMARY OF THE INVENTION

One aspect of the present invention is a motor including: a stator core extending in a direction of an axis line constituting a rotation center; a stator coil formed by winding a winding wire on the stator core; and a resin mold unit of a substantially cylindrical shape centered on the axis line, the resin mold unit covering an end portion in the direction of the axis line of the stator coil, in which the motor is configured to supply a coolant to a surface of the resin mold unit and is arranged so that the axis line is directed in a substantially vertical direction, and the resin mold unit includes a spiral groove portion centered on the axis line at least either an inner circumferential surface or an outer circumferential surface of the resin mold unit.

Another aspect of the present invention is a turbo-blower apparatus including the motor.

Still another aspect of the present invention is a production method for a motor, the method including: forming a stator coil by winding a winding wire on a stator core extending in a direction of an axis line that is a rotation center; arranging a molding die of a substantially cylindrical shape including a spiral protrusion centered on the axis line in a circumference of an end portion in the axis line direction of the stator coil; filling a resin between the end portion of the stator coil and the molding die; and removing the molding die by being twisted along the spiral protrusion after the resin is cured.

### BRIEF DESCRIPTION OF THE DRAWINGS

The objects, features, and advantages of the present invention will become more apparent from the following description of an embodiment with reference to the accompanying drawings, in which:

FIG. 1 is a sectional view illustrating a configuration of a turbo-blower apparatus according to an embodiment of the present invention;

FIG. 2 is a perspective view illustrating an appearance structure of a stator of FIG. 1;

FIG. 3 is a sectional view illustrating a main part configuration of the stator of FIG. 1;

FIG. 4 is a view illustrating a configuration of a spiral flow path in a stator of a motor according to the embodiment of the present invention;

FIG. 5 is a view illustrating a production method for a resin mold unit in the stator of the motor according to the embodiment of the present invention; and

FIG. 6 is a view illustrating a modified example of FIG. 3.

### DETAILED DESCRIPTION

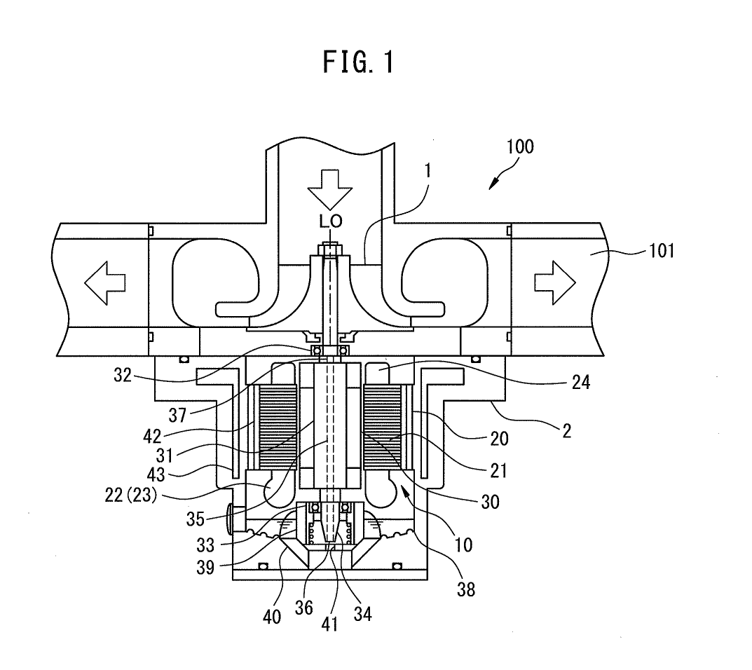

Hereinafter, with reference to FIG. 1 to FIG. 6, a motor according to one embodiment of the present invention will be described. FIG. 1 is a sectional view illustrating a configuration of a turbo-blower apparatus 100 including the motor according to the embodiment of the present invention. This turbo-blower apparatus 100 is used to supply a laser medium such as laser gas and the like to a laser oscillator via a cooler. More specifically, the turbo-blower apparatus 100 is a laser turbo-blower arranged in a circulation flow path of laser gas in a carbon dioxide gas laser apparatus or the like.

As illustrated in FIG. 1, the turbo-blower apparatus 100 is arranged in a pipe conduit interior 101 where laser gas is circulated and includes an impeller 1 rotating centered on an axis line L0 and a motor 10 for rotationally driving the impeller 1. A rotation center of the motor 10 is located on an extension of the axis line L0, and the motor 10 is arranged below the impeller 1. In other words, the impeller 1 and the motor 10 are arranged so that the rotation center (the axis line L0) is directed in a vertical direction (gravity direction). The impeller 1 is a centrifugal impeller which sucks in laser gas from the axis direction and blows the gas in a radial direction as illustrated by arrows of FIG. 1, and rotates at a rotation number of tens of thousands RPM.

The motor 10 includes a stator 20 of a substantially cylindrical shape and a rotor 30 supported on the inside of the stator 20 so as to be rotatable centered on the axis line L0. The motor 10 is arranged inside a housing 2 disposed below the impeller 1. The stator 20 includes a stator core 21 of a substantially cylindrical shape and a stator coil 22 mounted on the stator core 21. The stator core 21 is formed by laminating a plurality of magnetic steel sheets and fixed to the housing 2 interior. The stator coil 22 is formed by winding a winding wire 23 on a slot of the stator core 21. An axial end portion 24 (referred to as a coil end portion) of the stator coil 22 protrudes from the stator core 21. A resin mold unit is disposed in a circumference of the coil end portion 24, but an illustration thereof is omitted in FIG. 1.

The rotor 30 is fixed to an outer circumference of a shaft 31 by shrinkage fitting or the like, and the impeller 1 and the rotor 30 are coupled via the shaft 31. The shaft 31 is rotatably supported by a pair of upper and lower rolling bearings 32 and 33. An oil suction head 34 is disposed integrally with the shaft 31 in a lower end portion of the shaft 31. An oil pathway 35 is disposed along the axis line L0 direction inside the shaft 31 and the oil suction head 34. In a lower end portion of the oil suction head 34, an oil inlet 36 communicating with the oil pathway 35 is disposed. An oil outlet 37 is disposed in the shaft 31 between the upper rolling bearing 32 and the rotor 30.

An oil reservoir 38 is formed in an inner lower end portion of the housing 2. Lubricant and cooling oil is stored in the oil reservoir 38. In a circumference of the oil suction head 34, a cylindrical shaft support unit 39 is disposed integrally with the oil reservoir 38. A lower end portion of the oil suction head 34 is located on the inside of the shaft support unit 39. The oil of the oil reservoir 38 flows into an inner space of the shaft support unit 39 and the oil pathway 35 of the shaft 31 (the oil suction head 34) via an oil pathway 40 disposed in the oil reservoir 38 and a through hole 41 disposed in the shaft support unit 39. When the shaft 31 is not rotated, the oil in the oil reservoir 38, the oil in the shaft support unit 39, and the oil in the oil pathway 35 each have the same liquid level height.

A plurality of oil return pathways 42 are circumferentially formed along a longitudinal direction of the stator 20, i.e., the axis line L0 direction between the outer circumferential surface of the stator core 21 and the inner circumferential surface of the housing 2. A cooling water passage 43 is formed along the oil return pathway 42 in the housing 2 of the outside of the oil return pathway 42.

In the turbo-blower apparatus 100 described above, when the shaft 31 is rotated, the oil in the oil pathway 35 of the oil suction head 34 is pressed against an inner wall surface of the oil pathway 35 by a centrifugal force associated with the rotation of the shaft 31. At that time, a force component of a direction of pushing up the oil along the inner wall surface of the oil pathway 35 acts on the oil. As a result, the oil is rapidly sucked up and then released from the oil outlet 37 through the oil pathway 35 of the shaft interior. The released oil returns to the oil reservoir 38 through the oil return pathway 42. During this, the oil is cooled by cooling water of the cooling water passage 43. Thereafter, the oil flows into the inside of the shaft support unit 39 via the oil pathway 40 and the through hole 41. Such an oil circulation cools the motor 10 and supplies the oil also to the rolling bearings 32 and 33 as lubricant oil.

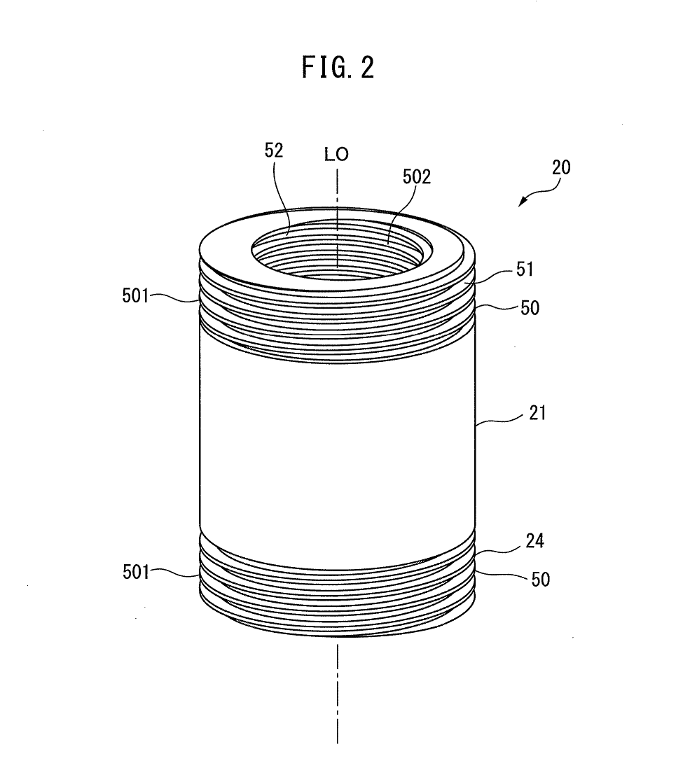

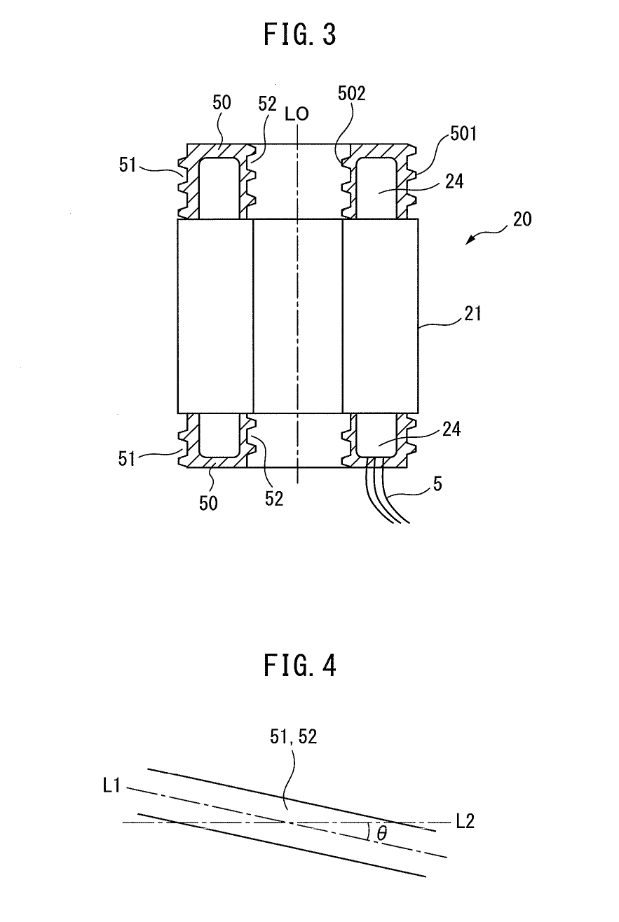

FIG. 2 is a perspective view illustrating an appearance structure of the stator 20, and FIG. 3 is a sectional view illustrating a main part configuration of the stator 20. As illustrated in FIGS. 2 and 3, a circumference of the coil end portion 24 is covered with a resin mold unit 50 which a molded body employing a resin as a component. The resin mold unit 50 has a substantially cylindrical shape centered on the axis line L0. In an outer circumferential surface 501 and an inner circumferential surface 502 of the resin mold unit 50, single or pluralities of spiral groove potions (fin grooves) 51 and 52 are formed from top to bottom centered on the axis line L0, respectively.

When single fin grooves 51 and 52 are formed, as illustrated in FIG. 4, an angle θ between a center line L1 of each of the fin grooves 51 and 52 and a horizontal line L2 is preferably reduced to lengthen the flow path. On the other hand, when pluralities of fin grooves 51 and 52 are formed, the angle θ between the center line L1 and the horizontal line L2 is made greater than the case of forming the single fin grooves 51 and 52, and the pluralities of fin grooves 51 and 52 may be formed by phase shifting so as not to intersect with each other. The fin grooves 51 and 52 may be disposed in any one of the outer circumferential surface 501 and the inner circumferential surface 502 of the resin mold unit 50. A resin material constituting the resin mold unit 50 is not specifically limited, but to enhance heat radiation performance of the stator coil 22, those exhibiting excellent thermal conductivity are preferably used. FIG. 3 illustrates a lead wire 5 connected to the coil end portion 24. It is possible that a connector is attached to the coil end portion 24 so that the lead wire 5 does not extend from the coil end portion 24.

When the coil end portion 24 is covered with the resin mold unit 50 and the spiral fin grooves 51 and 52 are disposed in the outer circumferential surface 501 and the inner circumferential surface 502 of the resin mold unit 50 in this manner, the oil released from the oil outlet 37 of the shaft 31 flows downward along the fin grooves 51 and 52, and further returns to the oil reservoir 38 via the oil return pathway 42 and the lower-side fin grooves 51 and 52.

Therefore, heat of the coil end portion 24 is absorbed by the oil and the coil end portion 24 can be cooled. The fin grooves 51 and 52 are spirally shaped and therefore, the flow path of the oil is lengthened and then the oil is widely brought into contact with a circumferential surface of the resin mold unit 50. Further, the oil does not remain on the way and uniformly flows circumferentially along the fin grooves 51 and 52 by gravity. Therefore, the stator coil 22 can be efficiently cooled.

In contrast, when, for example, the resin mold unit 50 does not have a fin groove, the oil released from the oil outlet 37 spreads radially, passes through an upper surface and a cylindrical surface (an inner circumferential surface or an outer circumferential surface) of the resin mold unit 50, and flows downward. In this case, a flow of the oil is non-uniform circumferentially and therefore, a temperature of the stator coil 22 may vary circumferentially.

On the other hand, also when, for example, a radial fin groove is disposed in an upper surface of the resin mold unit 50 and further a fin groove along the axis line L0 direction is disposed in a circumferential surface thereof, a flow of oil may become non-uniform circumferentially. Further, when a ring-like fin groove centered on the axis line L0 is disposed in a circumferential surface of the resin mold unit 50, oil may remain in the fin groove. Therefore, the stator coil 22 is difficult to be cooled efficiently.

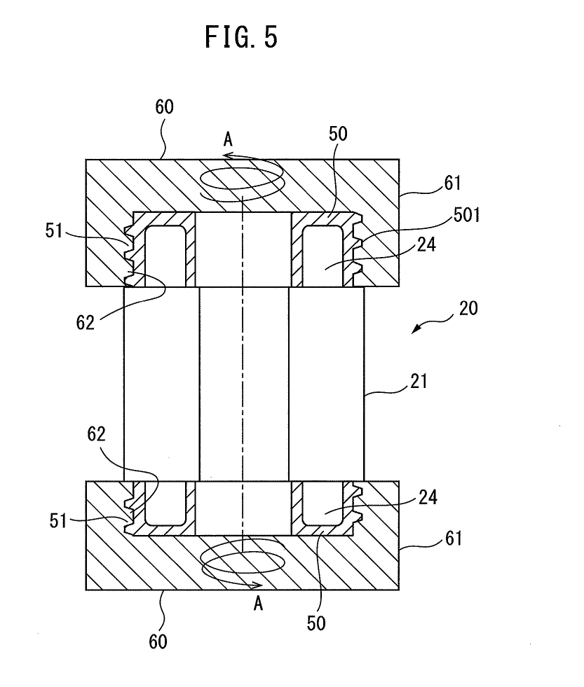

FIG. 5 is a view illustrating a production method for the resin mold unit 50. FIG. 5 illustrates a case where the fin groove 51 is disposed only in the outer circumferential surface 501 of the resin mold unit 50. In production of the resin mold unit 50, the stator coil 22 is formed previously by winding the winding wire 23 on the stator core 21. Then, as illustrated in FIG. 5, a molding die 60 is arranged in a circumference of the coil end portion 24.

The molding die 60 includes a cylindrically-shaped circumferential wall 61, and in an inner circumferential surface thereof, a spiral protrusion 62 corresponding to the fin groove 51 is disposed. Then, a resin is filled between the coil end portion 24 and the molding die 60 and then the molding die 60 is removed by being twisted along the fin groove 51 as illustrated by an arrow A of FIG. 5 after the resin is cured. Thereby, the spiral fin groove 51 is formed in the outer circumferential surface 501 of the resin mold unit 50. When the spiral protrusion 62 is disposed in an inner circumferential surface of the molding die 60 in this manner, the fin groove 51 need not be worked by cutting work or the like and therefore, the fin groove 51 can be easily formed.

It is possible that initially, the outer circumferential surface 501 and the inner circumferential surface 502 of the resin mold unit 50 are each formed as a cylindrical surface including no fin grooves 51 and 52, and thereafter, the fin grooves 51 and 52 are formed by cutting work. Alternatively, it is possible that the molding die 60 is circumferentially divided into two parts and then the resin mold unit 50 is formed between the molding die 60 and the coil end portion 24. In this case, the molding die 60 is easily removed after a resin is cured.

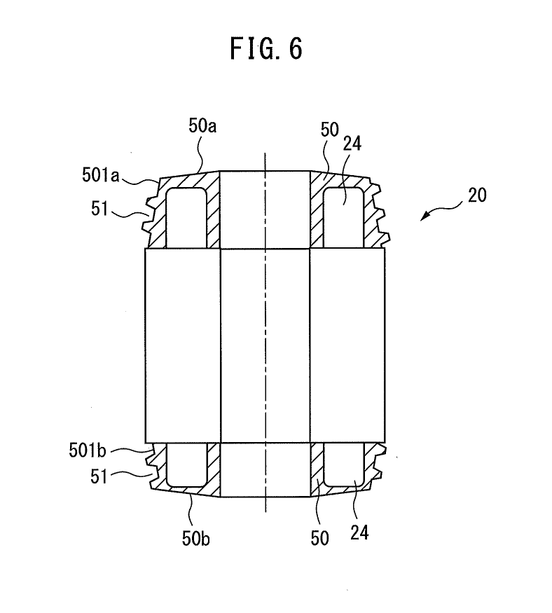

FIG. 6 is a view illustrating a modified example of FIG. 3. An upper surface 50a of the resin mold unit 50 slopes downward as going radially outward and a lower surface 50b thereof slopes downward as going radially inward. Further, an outer circumferential surface 501a extending to the upper surface 50a of the resin mold unit 50 slopes radially outward as going downward and an outer circumferential surface 501b extending to the lower surface 50b thereof slopes radially inward as going downward. In other words, the upper surface 50a, the lower surface 50b, and the outer circumferential surfaces 501a and 501b of the resin mold unit 50 each slope radially, and these are formed into a tapered shape. Therefore, the releasability of a molding die and also the fluidity of oil can be enhanced. In FIG. 6, the upper surface 50a, the lower surface 50b, and the outer circumferential surface 501 (501a and 501b) of the resin mold unit 50 are configured into a tapered shape, but at least one of the upper surface 50a, the lower surface 50b, the outer circumferential surface 501, and the inner circumferential surface 502 of the resin mold unit 50 may be configured into a tapered shape.

According to the present embodiment, the following operations and effects are achievable.
(1) The motor 10 includes the stator core 21 extending in a direction of the axis line L0 which is a rotation center, the stator coil 22 formed by winding the winding wire 23 on the stator core 21, and the resin mold unit 50 of a substantially cylindrical shape centered on the axis line L0 to cover an end portion (the coil end portion 24) in the direction of the axis line L0 of the stator coil 22; and is configured to supply oil to a surface of the resin mold unit 50. Further, the motor 10 is arranged so that the axis line L0 is directed in a vertical direction and the spiral fin grooves 51 and 52 centered on the axis line L0 are formed in at least either the outer circumferential surface 501 or the inner circumferential surface 502 of the resin mold unit 50. Thereby, oil flows on a circumferential surface of the resin mold unit 50 circumferentially along the fin grooves 51 and 52 by gravity and therefore, the motor 10 can be efficiently cooled.
(2) When at least either the inner circumferential surface 502 or the outer circumferential surface 501 of the resin mold unit 50 slopes radially centered on the axis line L0 (FIG. 6), the releasability of a molding die can be enhanced and also the fluidity of oil can be enhanced.
(3) Lubricant oil for the rolling bearings 32 and 33 is caused to flow in the fin grooves 51 and 52 and therefore, a coolant caused to flow in the fin grooves 51 and 52 need not be prepared separately.
(4) The motor 10 is applied to the turbo-blower apparatus 100 and therefore, can be preferably used as a driving motor for the impeller 1 where the axis line L0 (rotation center) is arranged toward a vertical direction.
(5) As the production method of the motor 10, the stator coil 22 is formed by winding the winding wire 23 on the stator core 21 extending in a direction of the axis line L0; the molding die 60 of a substantially cylindrical shape including the spiral protrusion 62 centered on the axis line L0 is arranged in a circumference of an end portion (the coil end portion 24) in the axis line L0 direction of the stator coil 22; a resin is filled between the end portion 24 of the stator coil 22 and the molding die 60; and the molding die 60 is removed by being twisted along the spiral protrusion 62 after the resin is cured (FIG. 5). Thereby, the spiral fin groove 51 can be easily formed in a circumferential surface of the resin mold unit 50.

In the above embodiment, the motor 10 is arranged so that the axis line L0 which is a rotation center is directed in a vertical direction. However, as long as oil flows along a circumferential surface of the resin mold unit 50 by gravity, the motor 10 may be arranged so that the axis line L0 is directed substantially in a vertical direction (in a substantially vertical direction). In the above embodiment, oil is supplied, as a colorant, to a circumferential surface of the resin mold unit 50. However, another coolant may be supplied. Although the motor 10 of the above embodiment is applied to the turbo-blower apparatus 100, it is applicable to another apparatus in the same manner.

It is possible that the above embodiment and one modified example or a plurality of modified examples can be optionally combined.

According to the present invention, a motor is arranged so that an axis line is directed in a substantially vertical direction; a spiral groove portion centered on the axis line is formed in at least either an inner circumferential surface or an outer circumferential surface of a resin mold unit; and a coolant is supplied to a surface of the resin mold unit. Therefore, the coolant flows on the surface of the resin mold unit circumferentially along the groove portion by gravity, and therefore the motor can be efficiently cooled.

The present invention has been described in association with the preferred embodiment, but it should be understood by those skilled in the art that various modifications and alterations may be made without departing from the disclosed scope of the claims to be described later.

1. A motor comprising:
a stator core extending in a direction of an axis line constituting a rotation center;
a stator coil formed by winding a winding wire on the stator core; and
a resin mold unit of a substantially cylindrical shape centered on the axis line, the resin mold unit covering an end portion in the direction of the axis line of the stator coil, wherein
the motor is configured to supply a coolant to a surface of the resin mold unit and is arranged so that the axis line is directed in a substantially vertical direction, and
the resin mold unit includes a spiral groove portion centered on the axis line at least either an inner circumferential surface or an outer circumferential surface of the resin mold unit.

2. The motor according to claim 1, wherein
at least one of an upper surface, a lower surface, the inner circumferential surface, and the outer circumferential surface of the resin mold unit slopes radially centered on the axis line.

3. The motor according to claim 1, wherein
the coolant is oil.

4. A turbo-blower apparatus comprising
the motor according to claim 1.

5. A production method for a motor, the method comprising:
forming a stator coil by winding a winding wire on a stator core extending in a direction of an axis line constituting a rotation center;
arranging a molding die of a substantially cylindrical shape including a spiral protrusion centered on the axis line in a circumference of an end portion in the axis line direction of the stator coil;
filling a resin between the end portion of the stator coil and the molding die; and
removing the molding die by being twisted along the spiral protrusion after the resin is cured.
